(19) United States
(12) Patent Application Publication
(10) Pub. No.: US 2019/0366763 A1
(43) Pub. Date: Dec. 5, 2019

(54) VEHICLE WHEEL

(71) Applicant: HONDA MOTOR CO., LTD., Tokyo (JP)

(72) Inventors: Masaaki NISHI, Wako-shi (JP); Toshinobu SAITO, Wako-shi (JP); Yusuke OSAWA, Wako-shi (JP); Youichi KAMIYAMA, Wako-shi (JP); Kaito YOSHIYAMA, Wako-shi (JP)

(21) Appl. No.: 16/426,172

(22) Filed: May 30, 2019

(30) Foreign Application Priority Data
Jun. 1, 2018 (JP) 2018-105833

(51) Int. Cl. B60B 21/02; B60B 21/12

(52) U.S. Cl. CPC B60B 21/023; B60B 21/12

(57) ABSTRACT

A vehicle wheel includes a Helmholtz resonator (sub-air chamber member) adhered on a rim, and the Helmholtz resonator (sub-air chamber member) includes a bottom plate and a side plate that rises from one edge of both edges of the bottom plate, and the bottom plate and the side plate are adhered on the rim. In the vehicle wheel, the Helmholtz resonator further includes an upper plate that is opposed to the bottom plate, and the upper plate is connected to the side plate at an opposite side of the one edge and inclined so as to come near the bottom plate at greater distances from the side plate.

### CROSS-REFERENCE TO RELATED APPLICATION

This application is based upon and claims priority from the Japanese Patent Application No. 2018-105833, filed on Jun. 1, 2018, the entire contents of which are incorporated herein by reference.

### BACKGROUND OF THE INVENTION

### 1. Field of the Invention

The present invention relates to a vehicle wheel.

### 2. Description of the Related Art

As an example of conventional art, there is known a Helmholtz resonator which is disposed on an outer circumferential surface of a well part in a wheel, and both edges of which projecting in the wheel width direction are engaged with a circumferential groove of a rim (for example, see Patent document 1: Japanese Unexamined Patent Application Publication No. 2012-45971).

The Helmholtz resonator allows the both edges thereof to be elastically deformed when pressed against the outer circumferential surface of the well part, thereby being easily fitted into the circumferential groove of the rim. Consequently, the Helmholtz resonator can be easily mounted on the wheel.

However, the conventional wheel with the Helmholtz resonator (for example, see Patent document 1) requires cutting and forming the circumferential groove for mounting the resonator on the rim. For this reason, the wheel has posed a problem in that a manufacturing process thereof becomes complicated to increase a manufacturing cost.

In order to solve the problem, for example, a resonator mounting structure is conceived in which the Helmholtz resonator is fixed to the wheel with an adhesive material.

However, in the Helmholtz resonator mounted on the outer circumferential surface of the well part, an extremely large centrifugal force is generated by high-speed rotation of the tire during vehicle traveling. For this reason, a vehicle wheel has been demanded which further improves fixing strength of the Helmholtz resonator mounted on the rim with an adhesive material.

The present invention has therefore been made in view of the above problems, and an object of the invention is to provide a vehicle wheel capable of further improving fixing strength of a Helmholtz resonator mounted on a rim with an adhesive material.

### SUMMARY OF THE INVENTION

In order to attain the above object, according to an aspect of the present invention, a vehicle wheel reflecting one aspect of the present invention includes a Helmholtz resonator adhered on a wheel, wherein the Helmholtz resonator includes a bottom plate and a side plate that rises from one edge of both edges of the bottom plate, and the bottom plate and the side plate are adhered on the wheel.

The vehicle wheel according to one aspect of the present invention makes it possible to further improve fixing strength of the Helmholtz resonator mounted on the rim with an adhesive material.

### BRIEF DESCRIPTION OF THE DRAWINGS

The features and advantages provided by one or more embodiments of the invention will become apparent from the detailed description given below and appended drawings which are given only by way of illustration, and thus are not intended as a definition of the limits of the present invention.

FIG. 1 is a perspective view of a vehicle wheel according to an embodiment of the present invention.

FIG. 2 is an overall perspective view of a Helmholtz resonator (sub-air chamber member).

FIG. 3 is a cross-sectional view taken along the line in FIG. 1.

FIG. 4 is a partial enlarged view of the part IV indicated by an arrow in FIG. 3.

FIG. 5 is a graph showing the relationship between a film thickness of an adhesive material interposed between a Helmholtz resonator (sub-air chamber member) and a rim, and shear strength and peel strength of the adhesive material.

FIG. 6 is an explanatory view of a laser-etched surface on a vertical wall of a well part.

FIG. 7 is a partial enlarged view of the part VII indicated by an arrow in FIG. 3.

FIG. 8 is an explanatory view of configuration of a vehicle wheel according to a first modification.

FIG. 9 is an explanatory view of configuration of a vehicle wheel according to a second modification.

FIG. 10 is an explanatory view of configuration of a vehicle wheel according to a third modification.

### DETAILED DESCRIPTION OF THE PREFERRED EMBODIMENTS

Hereinafter, vehicle wheels according to embodiments of the present invention will be described in detail with reference to the drawings as appropriate. Note that in the drawings to be referred to, reference sign “X” denotes a wheel circumferential direction; reference sign “Y” denotes a wheel width direction; and reference sign “Z” denotes a wheel radial direction.

In the description below, overall structure of a vehicle wheel will be first described, and then description will be given of a sub-air chamber member serving as a Helmholtz resonator and of a mounting structure of the sub-air chamber member on a rim by an adhesive material.

### <Overall Structure of Vehicle Wheel>

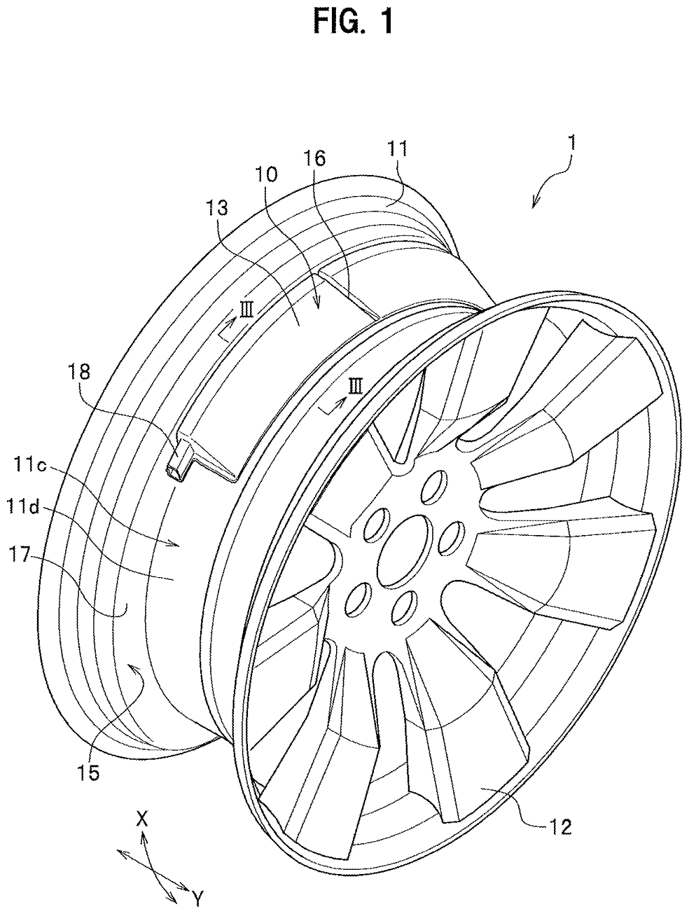

FIG. 1 is a perspective view of a vehicle wheel 1 according to an embodiment of the present invention.

As shown in FIG. 1, the vehicle wheel 1 according to the present embodiment is configured to allow a sub-air chamber member 10 (Helmholtz resonator) made of a synthetic resin such as polyamide resin to be mounted on a rim 11 made of metal such as aluminum alloy and magnesium alloy.

In FIG. 1, reference sign 12 denotes a disk for connecting the rim 11 to a hub (not shown).

The rim 11 includes a well part 11c which is concave inward (toward a rotation center) in the wheel radial direction between bead seats (not shown) formed on both end parts of the rim 11 in the wheel width direction Y. An outer circumferential surface 11d of the well part 11c is defined by a bottom face of the concave part and has substantially the same diameter on the wheel shaft throughout the wheel width direction Y.

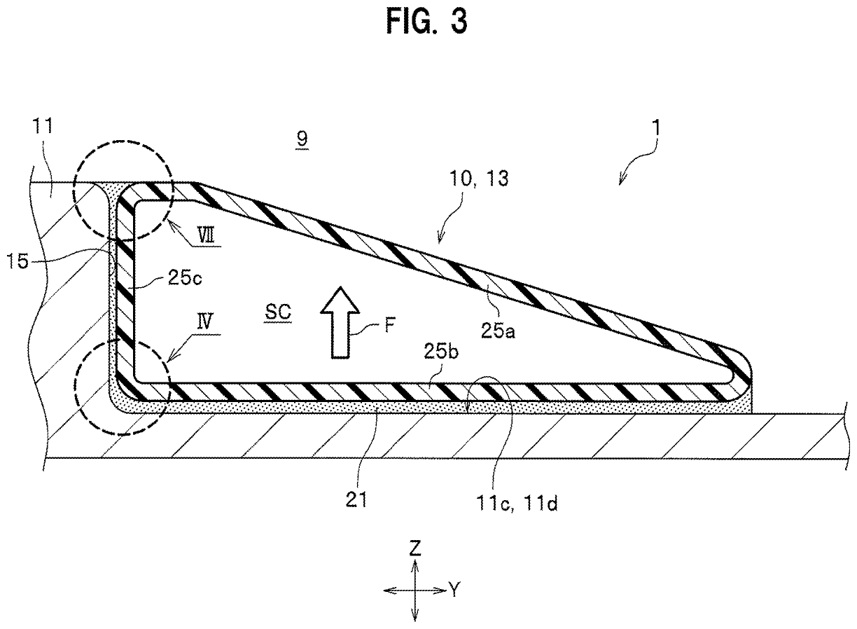

The rim 11 thus configured in the present embodiment is provided with a vertical wall 15 that extends in the wheel circumferential direction X. The vertical wall 15 in the present embodiment assumes that it is formed at an inner side in the wheel width direction Y and in a rising part 17 that erects from the outer circumferential surface 11d of the well part 11c toward a rim flange side. Note that the vertical wall 15 in the present embodiment is formed to allow an angle made between the vertical wall 15 and the outer circumferential surface 11d to be substantially a right angle (see FIG. 3) as described later.

### <Sub-Air Chamber Member>

Next, the sub-air chamber member 10 will be described.

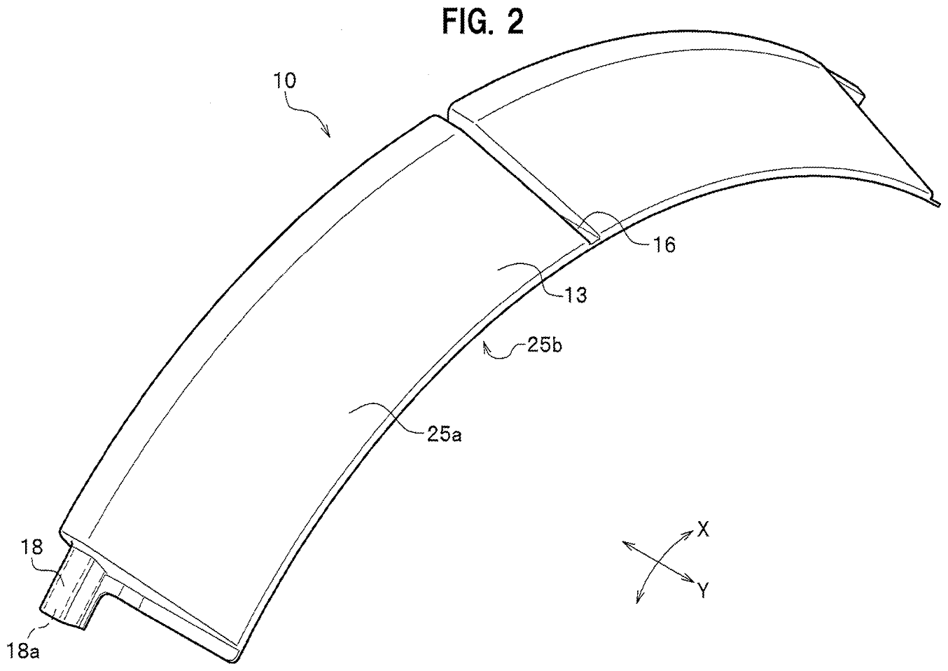

FIG. 2 is an overall perspective view of the sub-air chamber member 10. FIG. 3 is a cross-sectional view taken along the line in FIG. 1.

As shown in FIG. 2, the sub-air chamber member 10 is a member elongated in the wheel circumferential direction X and includes a main body 13 and a tubular body 18. The sub-air chamber member 10 is configured to have a symmetric shape in the wheel circumferential direction X with respect to a partition wall 16 that extends in the wheel width direction Y at the center of the main body 13.

The main body 13 is curved in a longitudinal direction thereof. In other words, the main body 13 is configured to follow the wheel circumferential direction X when the sub-air chamber member 10 is mounted on the outer circumferential surface 11d (see FIG. 1) of the well part 11c (see FIG. 1).

The main body 13 has a hollow part inside. The hollow part (not shown) forms a sub-air chamber SC (see FIG. 3) as described later. The hollow part is divided by the partition wall 16 into two parts in the wheel circumferential direction X.

As shown in FIG. 3, the main body 13 has the form of a nearly right triangle in cross section orthogonal to the longitudinal direction (the wheel circumferential direction X in FIG. 2).

More specifically, the main body 13 has configuration in which a bottom plate 25b that is disposed along the outer circumferential surface 11d of the well part 11c, a side plate 25c that is disposed along the vertical wall 15, and an upper plate 25a that forms a hypotenuse between the bottom plate 25b and the side plate 25c, are mutually connected so as to form a right triangle.

That is, the side plate 25c and the bottom plate 25b form a right angle by the angle of inclusion between them. The upper plate 25a is inclined so as to come near the bottom plate 25b at greater distances from the side plate 25c in the wheel width direction Y.

Note that the side plate 25c corresponds to “a side plate that rises from one edge of both edges of the bottom plate” set forth in the scope of claims.

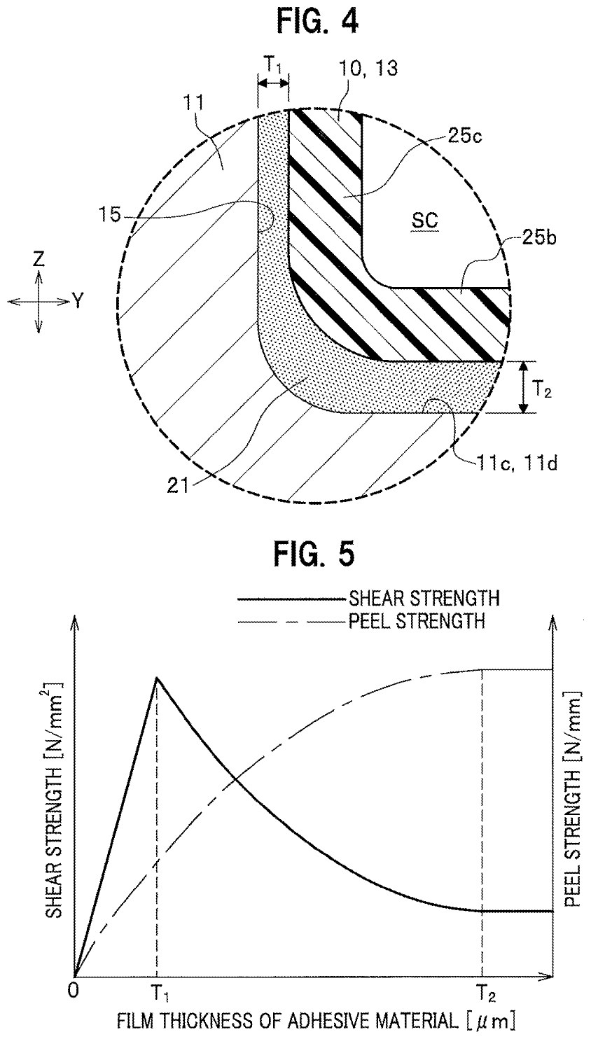

Moreover, an adhesive material 21 having film thicknesses T₁, T₂ (see FIG. 4) to be described later is interposed between the outer circumferential surface 11d of the well part 11c and the bottom plate 25b, and between the vertical wall 15 and the side plate 25c.

Thus, the upper plate 25a, the bottom plate 25b and the side plate 25c are formed to surround the sub-air chamber SC inside the main body 13.

Next, the tubular body 18 (see FIG. 1) will be described.

As shown in FIG. 1, the tubular body 18 is formed at a position biased to one side (the inner side of the vehicle wheel 1) in the wheel width direction Y on the main body 13 so as to protrude from the main body 13 in the wheel circumferential direction X.

The sub-air chamber member 10 in the present embodiment is formed, as described above, into a symmetric shape in the wheel circumferential direction X with respect to the partition wall 16. Accordingly, although only one tubular body 18 is shown in FIG. 1, the tubular bodies 18 in the present embodiment are disposed to form a pair at positions symmetrical to each other on both end parts in the longitudinal direction (the wheel circumferential direction X) of the main body 13.

As shown in FIG. 2, the tubular body 18 has a communication hole 18a formed inside.

The communication hole 18a allows the sub-air chamber SC (see FIG. 3) formed inside the main body 13 to be communicated with a tire air chamber 9 (see FIG. 3) which is to be formed between the well part 11c (see FIG. 3) and a tire (not shown).

The sub-air chamber member 10 in the present embodiment is a blow molded product using a synthetic resin such as polyamide resin as described above. Note that the above synthetic resin is not specifically limited, but polyamide resin containing polyamide MXD6 (Registered trade mark) as a base resin, and nylon 6 are especially preferably used.

### <Mounting Structure of Sub-Air Chamber Member>

Next, description will be given of a mounting structure of the sub-air chamber member 10 (see FIG. 1) on the rim 11 (see FIG. 1).

As shown in FIG. 3, the main body 13 of the sub-air chamber member 10 is connected via the adhesive material 21 to the rim 11. The adhesive material 21 forms a continuous film that ranges from the outer circumferential surface 11d of the well part 11c to the vertical wall 15.

FIG. 4 is a partial enlarged view of the part IV indicated by an arrow in FIG. 3. In FIG. 4, the same constituent element as in FIG. 3 is given the same reference sign and thus detailed explanation thereof is omitted.

As shown in FIG. 4, the film thickness T₁ of the adhesive material 21 on the vertical wall 15 is set to be thinner than the film thickness T₂ of the adhesive material 21 on the outer circumferential surface 11d of the well part 11c.

The adhesive material 21 has higher shear strength as it becomes thinner, and has higher peel strength as it becomes thicker.

Moreover, more preferable setting of film thicknesses of the adhesive material 21 satisfying the relation of “film thickness T₁<film thickness T₂” is as follows.

FIG. 5 is a graph showing the relationship between the film thickness [μm] of the adhesive material 21 interposed between the sub-air chamber member 10 and the rim 11 shown in FIG. 3, and shear strength [N/mm²] and peel strength [N/mm] of the adhesive material 21. Note that the shear strength [N/mm²] is measured on the basis of JIS K6850 (1999), and the peel strength [N/mm] is measured on the basis of JIS K6854 (1999).

As shown in FIG. 5, the shear strength [N/mm²] increases, then reaches a predetermined yield point (see the film thickness T₁) and then decreases as the film thickness of the adhesive material 21 (see FIG. 3) becomes increased from 0 [μm]. That is, the shear strength [N/mm²] becomes the maximum at the yield point (see the film thickness T₁).

Moreover, the peel strength [N/mm] gradually increases and then reaches a saturation point (see the film thickness T₂) as the film thickness becomes increased from 0 [μm]. That is, the peel strength [N/mm] becomes the maximum at the saturation point (see the film thickness T₂).

Accordingly, the sub-air chamber member 10 (see FIG. 3) in the present embodiment allows the film thickness of the adhesive material 21 (see FIG. 3) on the vertical wall 15 (see FIG. 3) to be set to T₁ shown in FIG. 5, and the film thickness of the adhesive material 21 on the outer circumferential surface 11d (see FIG. 3) to be set to T₂ shown in FIG. 5, thereby allowing the fixing strength of the sub-air chamber member 10 to the rim 11 to become the maximum.

Incidentally, the relation of the shear strength [N/mm²], the peel strength [N/mm], and the film thickness [μm] of the adhesive material 21 shown in FIG. 5 can be calculated by CAE (Computer Aided Engineering) analysis executed in advance according to materials of the rim 11 and the kind of the adhesive material 21 to be used.

Examples of the adhesive material 21 include thermoplastic resin-based adhesive such as ethylene-vinyl acetate resin; thermosetting resin-based adhesive such as epoxy resin, polyurethane resin, acrylic resin and polyamide resin; and elastomer-based adhesive such as synthetic rubber and thermoplastic elastomer, but the adhesive material is not limited to these examples.

Incidentally, the form of hardening of the adhesive material 21 is not specifically limited, but chemical reaction hardening is especially preferably used.

The adhesive material 21 can be coated on either the sub-air chamber member 10 or the rim 11. Moreover, the adhesive material 21 can also be coated on both of the sub-air chamber member 10 and the rim 11.

Examples of coating method for the adhesive material 21 include bar coating method, roll coating method, spray coating method, brush coating method, and hot-melt coating method, but the coating method is not limited to these examples.

Moreover, the applied surface of the adhesive material 21 (see FIG. 3) in the mounting structure of the sub-air chamber member 10 (see FIG. 3) is preferably roughened. It is more preferable that the applied surface is formed of a laser-etched surface above all.

In particular, it is still more preferable that the applied surface of the adhesive material 21 in which a shearing force is generated during action of a centrifugal force F (see FIG. 3) is formed of a laser-etched surface. In other words, it is still more preferable that the vertical wall 15 shown in FIG. 3, and/or the side plate 25c of the main body 13 are each formed of a laser-etched surface.

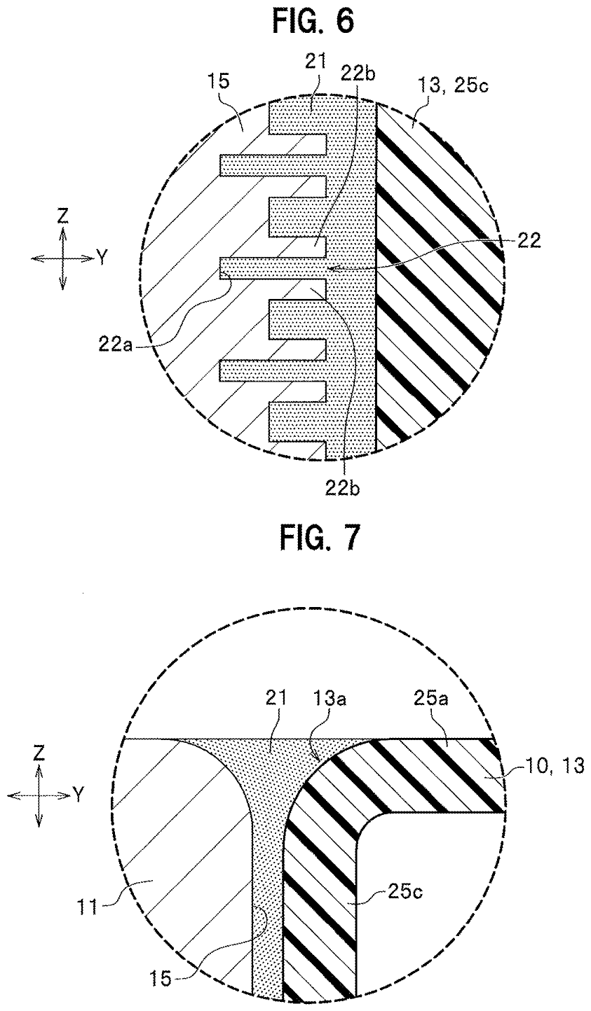

FIG. 6 is an explanatory view of a laser-etched surface 22 on the vertical wall 15. In FIG. 6, reference sign 25c denotes a side plate of the main body 13, and reference sign 21 denotes an adhesive material.

As shown in FIG. 6, the surface of the vertical wall 15 is formed of the laser-etched surface 22.

The laser-etched surface 22 is composed of an etched groove 22a and a ridge part 22b.

The etched groove 22a in the present embodiment assumes that it is formed on the vertical wall 15, e.g., when a YAG laser is scanned in one direction on the surface of the vertical wall 15, and extends with a predetermined groove depth from the front side of the page space in FIG. 6 toward the back side of the page space.

Moreover, the ridge part 22b in the present embodiment is formed with protrusion of a predetermined height at both sides in a width direction of the etched groove 22a, respectively, and extends in an extending direction of the etched groove 22a.

The laser-etched surface 22 is formed, e.g., by allowing a YAG laser to be scanned with a predetermined width of hatching on the surface of the vertical wall 15. More specifically, the YAG laser causes the etched groove 22a to be formed with a predetermined depth and substance eluted by laser irradiation deposits and hardens at both sides of the etched groove 22a, thereby allowing the ridge part 22b to be formed with a predetermined height.

Note that, although the extending direction of the etched groove 22a and the ridge part 22b in the present embodiment assumes that it is set to the wheel circumferential direction X, it is not limited to the wheel circumferential direction X.

The present embodiment allows the laser-etched surface 22 to be formed on the vertical wall 15, thereby allowing the adhesive material 21 to be filled in the etched groove 22a and between adjacent ridge parts 22b. Moreover, on the laser-etched surface 22 although not shown, an end part of the ridge part 22b is displaced in a groove width direction of the etched groove 22a to allow a side face of the ridge part 22b to overhang, or the end parts of the adjacent ridge parts 22b are connected to each other on the etched groove 22a to partially form an arch.

This allows anchor structure of the adhesive material 21 to be constructed on the laser-etched surface 22 by the adhesive material 21 deeply entering the etched groove 22a and the adhesive material 21 engaged with the overhanging portion and the arch.

Accordingly, the fixing strength of the sub-air chamber member 10 to the rim 11 becomes enhanced.

Moreover, the laser-etched surface 22 makes it possible to further improve the fixing strength of the sub-air chamber member 10 to the rim 11 through enhancing effects of wettability accompanied by surface free energy structure of solid parts of metal (see Young's equation of angle of contact).

Note that it goes without saying that the laser-etched surface 22 can also be formed on the side plate 25c of the main body 13 as described above.

FIG. 7 is a partial enlarged view of the part VII indicated by an arrow in FIG. 3.

As shown in FIG. 7, a corner radius section 13a is formed at a junction of the upper plate 25a and the side plate 25c of the main body 13.

The adhesive material 21 located between the vertical wall 15 and the side plate 25c spreads above the corner radius section 13a to cover the corner radius section 13a from above.

The adhesive material 21 covering the corner radius section 13a from above makes it possible to further enhance the fixing strength of the sub-air chamber member 10 to the rim 11.

### <Operation and Effects>

Next, description will be given of operation and effects of the vehicle wheel 1 according to the present embodiment.

The vehicle wheel 1 according to the present embodiment allows the sub-air chamber member 10 to be mounted on the rim 11 with the adhesive material 21.

The vehicle wheel 1 thus configured differs from the conventional vehicle wheel (for example, see Patent document 1) and has no need to cut and form a circumferential groove for mounting the sub-air chamber member 10 on the rim 11. Accordingly, the vehicle wheel 1 makes it possible to simplify a manufacturing process to reduce a manufacturing cost as compared to the conventional art.

Moreover, the vehicle wheel 1 allows the bottom plate 25b of the sub-air chamber member 10 and the outer circumferential surface 11d of the well part 11c to be adhered to each other via the adhesive material 21, and allows the side plate 25c of the sub-air chamber member 10 and the vertical wall 15 of the well part 11c to be adhered to each other via the adhesive material 21.

In the vehicle wheel 1 thus configured, the adhesive material 11 interposed between the outer circumferential surface 11d and the bottom plate 25b resists the centrifugal force F that acts on the sub-air chamber member 10 in a peeling direction of the adhesive material 21. Moreover, the adhesive material 11 interposed between the vertical wall 15 and the side plate 25c resists the centrifugal force F that acts on the sub-air chamber member 10 in a shearing direction of the adhesive material 21.

That is, the adhesive material 11 resists the centrifugal force F on a limited adhering surface of the bottom plate 25b and the side plate 25c in both directions of the peeling direction and the shearing direction, thereby making it possible to further improve the fixing strength of the sub-air chamber member 10 to the rim 11.

Moreover, in the vehicle wheel 1 according to the present embodiment as shown in FIG. 3, the upper plate 25a of the sub-air chamber member 10 is inclined so as to come near the bottom plate 25b at greater distances from the vertical wall 15.

On the other hand, the centrifugal force acting on the upper plate 25a during rotation of the wheel is expressed by mrω², where ω is an angle velocity. That is, when attention is focused on a mass point m of materials (e.g., resin) forming the upper plate 25a, a distance r from the rotation center of the mass point m of the upper plate 25a inclined as described above becomes shorter at greater distances from the vertical wall 15. As a result, the centrifugal force acting on the sub-air chamber member 10 becomes smaller at greater distances from the vertical wall 15.

On the contrary, the centrifugal force acts most largely on “a part adjacent to the vertical wall 15” of the sub-air chamber member 10, to which mass of materials forming the side plate 25c (side wall) is added.

“The part adjacent to the vertical wall 15” of the sub-air chamber member 10 exhibits the fixing strength to the rim 11 based on both adhesive strength of the side plate 25c (“shear strength” of the adhesive material 21) and adhesive strength of the bottom plate 25b (“peel strength” of the adhesive material 21). This allows the fixing strength of “the part adjacent to the vertical wall 15” of the sub-air chamber member 10 to the rim 11 to be extremely enhanced.

Moreover, shear adhesion of the sub-air chamber member 10 to the rim 11, obtained by only the adhesive material 21 by which the side plate 25c is adhered on the vertical wall 15, becomes gradually weak at greater distances from the vertical wall 15. However, the centrifugal force acting on the sub-air chamber member 10 in the present embodiment becomes smaller at greater distances from the vertical wall 15 by the upper plate 25a inclined as described above. This allows the fixing strength of the sub-air chamber member 10 to the rim 11 to become more excellent, combined with the “peel strength” based on the adhesive material 21 interposed between the outer circumferential surface 11d and the bottom plate 25b.

Furthermore, the vehicle wheel 1 according to the present embodiment allows the film thicknesses of the adhesive material 21 to satisfy the relation of “film thickness T₁<film thickness T₂” described above, thus allowing both “shear strength” of the adhesive material 21 on the vertical wall 15 and “peel strength” of the adhesive material 21 on the outer circumferential surface 11d to be enhanced. This makes it possible to further enhance the fixing strength of the sub-air chamber member 10 to the rim 11.

Although the embodiment of the present invention has been described above, the present invention is not limited to the above embodiment and can be put into practice in various forms.

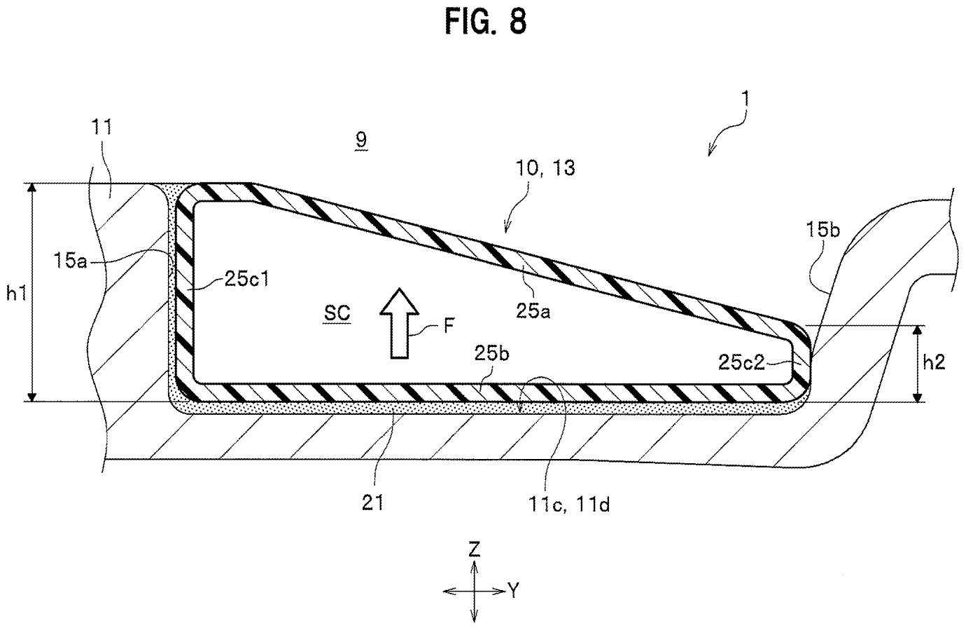

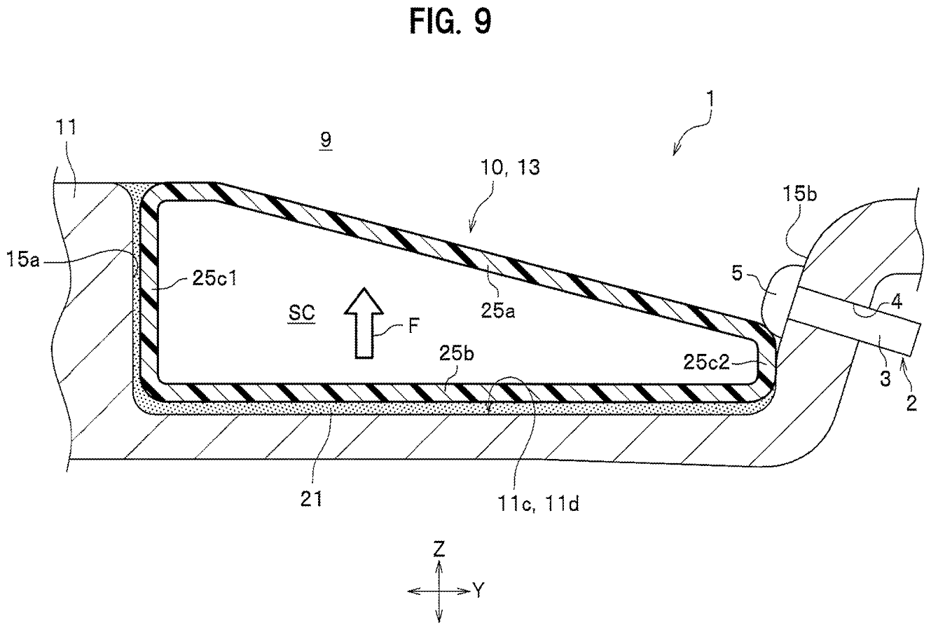

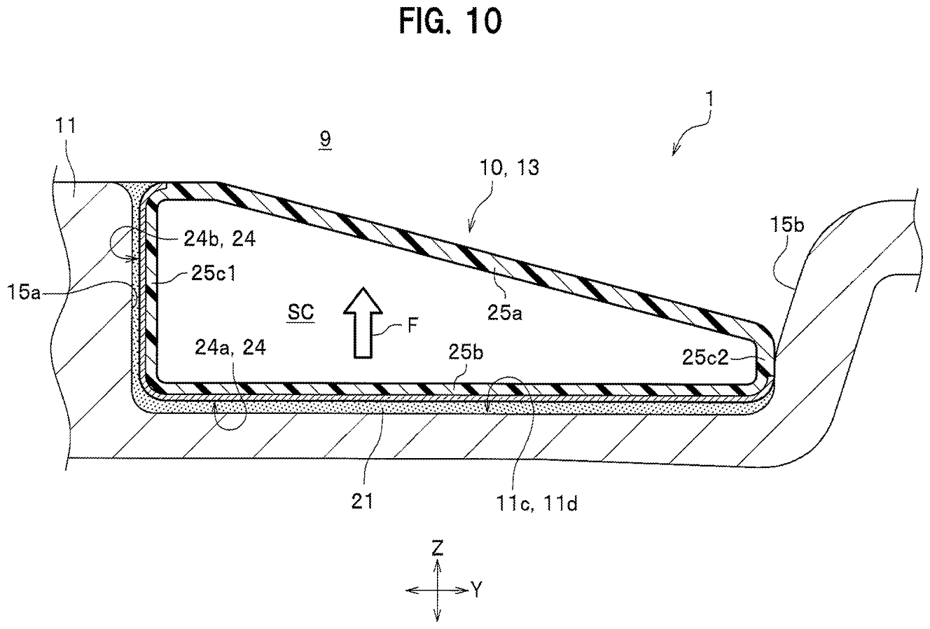

FIG. 8 is an explanatory view of configuration of a vehicle wheel 1 according to a first modification. FIG. 9 is an explanatory view of configuration of a vehicle wheel 1 according to a second modification. FIG. 10 is an explanatory view of configuration of a vehicle wheel 1 according to a third modification. Note that in the first to third modifications, the same constituent element as that in the above embodiment is given the same reference sign and thus detailed explanation thereof is omitted.

As shown in FIG. 8, in the vehicle wheel 1 according to the first modification, the main body 13 has a nearly right angle trapezoidal shape in cross section orthogonal to the longitudinal direction thereof.

The main body 13 is disposed so as to be fitted between a vertical wall 15a that rises from the outer circumferential surface 11d of the well part 11c toward the rim flange side at the inner side in the wheel width direction Y, and a vertical wall 15b that rises from the outer circumferential surface 11d of the well part 11c toward the rim flange side at the outer side in the wheel width direction Y.

Note that the vertical wall 15a is formed to allow an angle made between the vertical wall 15a and the outer circumferential surface 11d to be substantially a right angle in the same manner as the vertical wall 15 (see FIG. 3) in the embodiment described above.

Moreover, the vertical wall 15b is inclined so as to open outward in the wheel width direction Y as it extends outward in the wheel radial direction Z.

The main body 13 is provided with the bottom plate 25b that is disposed along the outer circumferential surface 11d of the well part 11c, a first side plate 25c1 that is disposed along the vertical wall 15a, a second side plate 25c2 that is disposed along the vertical wall 15b, and the upper plate 25a that connects the first side plate 25c1 and the second side plate 25c2 with each other above the bottom plate 25b.

That is, the angle made between the outer circumferential surface 11d of the well part 11c and the vertical wall 15a is substantially a right angle, thereby allowing the bottom plate 25b and the first side plate 25c1 to make substantially a right angle, and the bottom plate 25b and the second side plate 25c2 to make substantially a right angle. In other words, the main body 13 in cross section allows the second side plate 25c2 to form an upper base of the nearly right angle trapezoidal shape, and the first side plate 25c1 to form a lower base of the nearly right angle trapezoidal shape.

Moreover, a height h2 from the bottom plate 25b of the second side plate 25c2 is set to be lower than a height h1 from the bottom plate 25b of the first side plate 25c1.

This allows the upper plate 25a to be inclined so as to be displaced inward in the wheel radial direction Z from the first side plate 25c1 to the second side plate 25c2.

The bottom plate 25b, the first side plate 25c1, the second side plate 25c2 and the upper plate 25a thus configured are formed to surround the sub-air chamber SC inside the main body 13.

Moreover, the vertical wall 15a and the first side plate 25c1 are adhered to each other via the adhesive material 21 having the film thickness T₁ (see FIG. 4), and the bottom plate 25b and the outer circumferential surface 11d of the well part 11c are adhered to each other via the adhesive material 21 having the film thickness T₂ (see FIG. 4). The film thickness T₁ is set to be thinner than the film thickness T₂ (film thickness T₁<film thickness T₂).

Note that the second side plate 25c2 is not adhered on the rim 11 and corresponds to “a side plate that rises from the other edge of both edges of the bottom plate” set forth in the scope of claims.

The vehicle wheel 1 according to the first modification allows the height h2 of the second side plate 25c2 not adhered on the rim 11 to be lower than the height h1 of the first side plate 25c1 adhered on the rim 11.

In the vehicle wheel 1 thus configured, the distance r from the rotation center of the mass point m of materials forming the upper plate 25a, in other words, the mass point m being a constituent element of the centrifugal force F (mrω², where ω is a turning angle velocity), becomes shorter at greater distances from the first side plate 25c1. As a result, the centrifugal force F acting on the main body 13 becomes smaller becomes smaller at greater distances from the first side plate 25c1 adhered on the rim 11.

Accordingly, the vehicle wheel 1 makes it possible to omit adhesion to the rim 11 on the second side plate 25c2 side.

Moreover, in the vehicle wheel 1 according to the first modification, the film thickness T₂ of the adhesive material 21 on the outer circumferential surface 11d of the well part 11c is thicker than the film thickness T₁ of the adhesive material 21 on the vertical wall 15a (T₁<T₂). This makes it possible to further improve the fixing strength of the sub-air chamber member 10 to the rim 11 while omitting adhesion to the rim 11 on the second side plate 25c2 side of the vehicle wheel 1.

Furthermore, the vehicle wheel 1 according to the first modification allows the cross-sectional shape of the main body 13 to be a nearly right angle trapezoidal shape, thus making it possible to allow the sub-air chamber SC to secure a larger volume than the main body 13 having the cross-sectional shape of a nearly right triangle in the embodiment described above.

As shown in FIG. 9, the vehicle wheel 1 according to the second modification has a tire valve 2 schematically shown in the figure, which is mounted on the rim 11 forming the vertical wall 15b.

The tire valve 2 has one end facing the inside of the tire air chamber 9, and the other end facing the outside of the rim 11. Moreover, a valve stem 3 having a valve core (not shown) inside is press-fitted into a valve insertion hole 4 provided in the rim 11.

The tire valve 2 allows an elastic member (not shown) to cover the valve stem 3 and is swelled at an air discharge side thereof to form a mounting reinforcement part 5.

The vehicle wheel 1 according to the second modification allows the mounting reinforcement part 5 to be disposed at an upper end (on the outer side in the wheel radial direction Z) in a height direction of the second side plate 25c2 not adhered on the rim 11.

Moreover, the mounting reinforcement part 5 abuts on the second side plate 25c2 from the outer side in the wheel radial direction Z.

This allows the valve stem 3 (the mounting reinforcement part 5) to constitute what is called a stopper member for the sub-air chamber member 10, which prevents the sub-air chamber member 10 from being displaced outward in the wheel radial direction Z due to the centrifugal force F.

According to the vehicle wheel 1 of the second modification thus configured, when the centrifugal force F is applied to the sub-air chamber member 10, the fixing strength of the sub-air chamber member 10 to the rim 11 can be extremely enhanced on the side of the second side plate 25c2 not adhered on the rim 11.

Note that, although the tire valve 2 is used as the stopper member in the vehicle wheel 1 of the second modification, another member may be disposed as the stopper member, separately from the tire valve 2.

As shown in FIG. 10, in the vehicle wheel 1 according to the third modification, the main body 13 of the sub-air chamber member 10 has a metal plate 24 serving as a smoothing member for adhesion, on opposed surfaces 24a, 24b that are opposed to the outer circumferential surface 11d of the well part 11c and the vertical wall 15a.

The metal plate 24 (the smoothing member for adhesion) assumes that it is formed of the same material as that of the rim 11, but the material is not limited to this example.

The metal plate 24 allows the opposed surface 24a opposed to the outer circumferential surface 11d to have a flat surface for adhesion of the adhesive material 21. As for the flat surface, the surface of the metal plate 24 is treated, e.g., by electrolytic polishing or buffing, so as to have the degree of flatness of 1 μm or less.

Moreover, the opposed surface 24b of the metal plate 24 opposed to the vertical wall 15a is obtained by performing flattening treatment described above, followed by performing laser-etching (see the laser-etched surface 22 in FIG. 6).

The sub-air chamber member 10 thus configured can be obtained by insert molding in which the metal plate 24 is arranged in a metal mold beforehand.

The vehicle wheel 1 (see FIG. 10) of the third modification thus configured allows the opposed surfaces 24a, 24b of the sub-air chamber member 10 to the rim 11 to have a flat surface, thus facilitating control of film thicknesses of the adhesive material 21. This makes it possible for the vehicle wheel 1 to more reliably enhance the fixing strength of the sub-air chamber member 10 to the rim 11.

Moreover, the vehicle wheel 1 of the third modification makes it possible to further enhance rigidity of the main body 13 of the sub-air chamber member 10, through reinforcing effect by the metal plate 24.

Furthermore, the vehicle wheel 1 of the third modification allows the opposed surface 24b of the metal plate 24 opposed to the vertical wall 15a to be formed of the laser-etched surface 22, thus allowing the fixing strength of the sub-air chamber member 10 to the rim 11 to be further increased.

Although embodiments of the present invention have been described and illustrated in detail, the disclosed embodiments are made for purposes of illustration and example only and not limitation. The scope of the present invention should be interpreted by terms of the appended claims.

### DESCRIPTION OF REFERENCE SIGNS

1: Vehicle wheel; 2: Tire valve (Stopper member); 5: Mounting reinforcement part; 10: Sub-air chamber member (Helmholtz resonator); 11: Rim (Wheel); 11c: Well part; 11d: Outer circumferential surface; 13: Main body; 13a: Corner radius section; 15a: Vertical wall; 15b: Vertical wall; 18: Tubular body; 18a: Communication hole; 21: Adhesive material; 22: Laser-etched surface; 22a: Etched groove; 22b: Ridge part; 24: Metal plate; 25a: Upper plate; 25b: Bottom plate; 25c: Side plate; 25c1: First side plate (Side plate); 25c2: Second side plate (Side plate); F: Centrifugal force; SC: Sub-air chamber; T1: Film thickness; T2: Film thickness; X: Wheel circumferential direction; Y: Wheel width direction; Z: Wheel radial direction

What is claimed is:

1. A vehicle wheel comprising
a Helmholtz resonator adhered on a wheel, wherein
the Helmholtz resonator includes a bottom plate and a side plate that rises from one edge of both edges of the bottom plate, and
the bottom plate and the side plate are adhered on the wheel.

2. The vehicle wheel according to claim 1, wherein
the Helmholtz resonator further includes an upper plate that is opposed to the bottom plate, and
the upper plate is connected to the side plate at an opposite side of the one edge and inclined so as to come near the bottom plate at greater distances from the side plate.

3. The vehicle wheel according to claim 1, wherein
the Helmholtz resonator further includes a side plate that rises from the other edge of both edges of the bottom plate and is not adhered on the wheel, and
a height from the bottom plate of the side plate not adhered on the wheel, of the respective side plates on both edges of the bottom plate, is set to be lower than a height from the bottom plate of the side plate adhered on the wheel.

4. The vehicle wheel according to claim 1, further comprising
a stopper member for the Helmholtz resonator, provided at a predetermined position on the wheel on the other edge side of both edges of the bottom plate.

5. The vehicle wheel according to claim 4, wherein
the stopper member is composed of a tire valve.
